(19) United States
(12) Patent Application Publication
(10) Pub. No.: US 2025/0222468 A1
(43) Pub. Date: Jul. 10, 2025

(54) DUST COLLECTION PLATE AND PURIFICATION DEVICE

(71) Applicant: AirQuality Technology (Shanghai) Co., Ltd., Shanghai (CN)

(72) Inventors: Shidan LONG, Shanghai (CN); Shanqing MENG, Shanghai (CN); Lisun WANG, Shanghai (CN)

(21) Appl. No.: 19/012,128

(22) Filed: Jan. 7, 2025

Related U.S. Application Data
(63) Continuation of application No. PCT/CN2024/132606, filed on Nov. 18, 2024.

(30) Foreign Application Priority Data
Jan. 10, 2024 (CN) 2024100386405

(51) Int. Cl. B03C 3/47

(52) U.S. Cl. CPC B03C 3/47

(57) ABSTRACT

The present invention relates to a dust collection plate and a purification device, and belongs to the technical field of air purification. The dust collection plate includes a body, where the body includes a rigid insulation layer and a conductive layer, the conductive layer is located on an upper surface and a lower surface of the rigid insulation layer, and a plurality of fixed mounting positions are provided on an edge of the body in a length direction thereof. According to the present invention, the technical problems of short service life caused by the use of a metal pole plate in the existing technology, the influence on the purification efficiency due to tip discharge, large weight, high material cost as well as high transportation cost can be solved.

### CROSS-REFERENCE TO RELATED APPLICATIONS

The present application claims priority to Chinese Patent Application No. 2024100386405, filed Jan. 10, 2024, the entire disclosure of which is incorporated herein by reference.

### TECHNICAL FIELD

The present invention belongs to the technical field of air purification, and particularly relates to a dust collection plate and a purification device.

### BACKGROUND

Currently, the mainstream technologies for air purification are divided into a filtration technology and an electrostatic technology. The filtration technology filters or adsorbs pollutants in the air through fibers and fiber-based filtering materials, thereby purifying the air. The technology is mature and relatively stable in operation. However, the labor cost, material cost, operation cost and maintenance cost are very high, and improper maintenance may pose certain safety risks. Due to the continuous interception of pollutants in the air by filter materials, the gaps between fibers are constantly blocked, and wind resistance is increasing. Therefore, frequent cleaning and replacement of filter materials are required. Meanwhile, bacteria and viruses in the air trapped in filter materials can cause the problems such as bacterial growth, mold growth, and odor. The electrostatic technology charges particulate matters in gas through ionization modules, and the charged particulate matters are adsorbed by the electric field formed by a dust collection module to complete purification.

Various high-voltage electrostatic dust removal devices developed and designed using the principles of electrostatic technology can purify wide flow rate and complete particle pollution. The high-voltage electrostatic dust removal devices can achieve relatively stable use in environments such as different temperatures and humidities, and can be well applied to air filtration treatment in household, commercial, industrial, tunnel, subway and other fields. The high-voltage electrostatic dust removal devices have the technical characteristics of long service life, high purification efficiency, low operating costs, and low maintenance costs. At present, most of the high-voltage electrostatic dust removal devices use a metal pole plate, and the metal pole plate has the following disadvantages: 1. the metal pole plate is prone to corrosion, affecting the service life; 2. an edge of the metal pole plate is prone to burring and generating tip discharge, thereby affecting the purification efficiency; and 3. the metal pole plate is heavy with high material cost and high transportation cost.

### SUMMARY

For various shortcomings in the prior art, a dust collection plate and a purification device are now proposed, to solve the technical problems of short service life caused by the use of a metal pole plate in the existing technology, the influence on the purification efficiency due to tip discharge, large weight, high material cost as well as high transportation cost.

To achieve the foregoing objective, the present invention provides the following technical solution.

According to a first aspect, the present invention provides a dust collection plate, including a body, where the body includes a rigid insulation layer and a conductive layer, the conductive layer is located on an upper surface and a lower surface of the rigid insulation layer, and a plurality of fixed mounting positions are provided on an edge of the body in a length direction thereof.

This technical solution is further provided as follows: the fixed mounting positions are set as slotted openings and/or semicircular openings, and adjacent fixed mounting positions have different opening depths.

This technical solution is further provided as follows: a plurality of avoiding ports are also provided on the edge of the body in a length direction thereof, the fixed mounting positions are provided spaced apart from the avoiding ports, the avoiding ports have different opening depths from the fixed mounting positions, and the avoiding ports and the fixed mounting positions are set as slotted openings and/or semicircular openings.

This technical solution is further provided as follows: grooves extending along a length direction of the body are provided inside the fixed mounting positions.

This technical solution is further provided as follows: an end portion of the body serves as a power connection end, and the power connection end is provided with a necked receiving power connection port.

This technical solution is further provided as follows: the conductive layer has a length less than or equal to that of the rigid insulation layer, and the conductive layer extends to the power connection end.

This technical solution is further provided as follows: one end portion of the conductive layer located at the power connection end has an area less than that the other end portion of the conductive layer.

This technical solution is further provided as follows: the end portion of the body is provided with a process circular hole, and a minimum spacing between the process circular hole and the end portion of the body is 0-4 mm.

This technical solution is further provided as follows: spacings between an edge of the conductive layer and the edge of the body are equal.

This technical solution is further provided as follows: the conductive layer is made of a conductive material and an additive, the conductive material including graphite, graphene or conductive ink, and the additive including organosilicon; and the rigid insulation layer is made of one or more of polycarbonate, polypropylene, ABS plastic, polyamide, polyformaldehyde, polytetrafluoroethylene, glass fiber reinforced plastic and phenolic plastic.

This technical solution is further provided as follows: the rigid insulation layer has a thickness of 0.1-2 mm, and the conductive layer has a thickness of 0.005-0.2 mm.

According to a second aspect, the present invention provides a purification device, including a frame body, where a plurality of ground dust collection plates and high-voltage dust collection plates provided in an alternately superimposed manner are provided inside the frame body, and the ground dust collection plates and the high-voltage dust collection plates use the dust collection plate.

This technical solution is further provided as follows: the ground dust collection plates and the high-voltage dust collection plates are connected with a fixed separator, respectively, and the fixed separator is an insulation adhesive and/or a rigid insulation part.

This technical solution is further provided as follows: the ground dust collection plates and the high-voltage dust collection plates are provided in a 180° staggered manner, and insulators are provided between the frame body and the end portions of the ground dust collection plates, and between the frame body and the end portions of the high-voltage dust collection plates.

This technical solution is further provided as follows: the purification and dust removal device further includes a high-voltage power supply, where the high-voltage power supply is located inside or outside the frame body.

This technical solution is further provided as follows: a plurality of ground dust collection plates and high-voltage dust collection plates provided in an alternately superimposed manner form a purification unit, a plurality of purification units are provided in the frame body, and insulation plates are provided between adjacent purification units.

The present invention has the following beneficial effects:
by providing the rigid insulation layer, and under the premise of guaranteeing the strength and stability of the dust collection plate, the thickness of the dust collection plate is minimized, it is lightweight with low material and transportation costs, it is corrosion-resistant compared with the metal pole plate, which helps to prolong the service life, and there is no burr, which avoids the influence on the purification efficiency due to tip discharge. The purification device made of the dust collection plate with the structure has a larger effective ventilation area per unit area, a larger dust collection area and a larger dust holding capacity, so that the efficiency is higher and the maintenance cycle is longer.

### BRIEF DESCRIPTION OF THE DRAWINGS

FIG. 1 is a top view of a dust collection plate according to an embodiment of the present invention;

FIG. 2 is a side view of a dust collection plate according to an embodiment of the present invention;

FIG. 3 is a top view of another implementation of a dust collection plate according to an embodiment of the present invention;

FIG. 4 is a top view of another implementation of a dust collection plate according to an embodiment of the present invention;

FIG. 5 is a top view of another implementation of a dust collection plate according to an embodiment of the present invention;

FIG. 6 is a top view of another implementation of a dust collection plate according to an embodiment of the present invention;

FIG. 7 is a top view of another implementation of a dust collection plate according to an embodiment of the present invention;

FIG. 8 is a top view of another implementation of a dust collection plate according to an embodiment of the present invention;

FIG. 9 is a top view of another implementation of a dust collection plate according to an embodiment of the present invention;

FIG. 10 is a top view of another implementation of a dust collection plate according to an embodiment of the present invention;

FIG. 11 is a top view of another implementation of a dust collection plate according to an embodiment of the present invention;

FIG. 12 is a schematic diagram of a purification device according to an embodiment of the present invention;

FIG. 13 is an explosion diagram of a purification device according to an embodiment of the present invention;

FIG. 14 is a partial schematic diagram at a position A in FIG. 13.

### DETAILED DESCRIPTION OF THE EMBODIMENTS

To make those skilled in the art better understand the technical solutions of the present invention, the technical solutions of the present invention are clearly and completely described below with reference to the accompanying drawings of the present invention. Other embodiments obtained by a person of ordinary skill in the art based on the embodiments of the present application without creative efforts shall fall within the protection scope of the present application. Moreover, the directional terms mentioned in the following embodiments, such as “up”, “down”, “left”, “right”, etc., are merely referring to the directions in the accompanying drawings. Therefore, the used directional terms are intended to illustrate rather than limit the present invention.

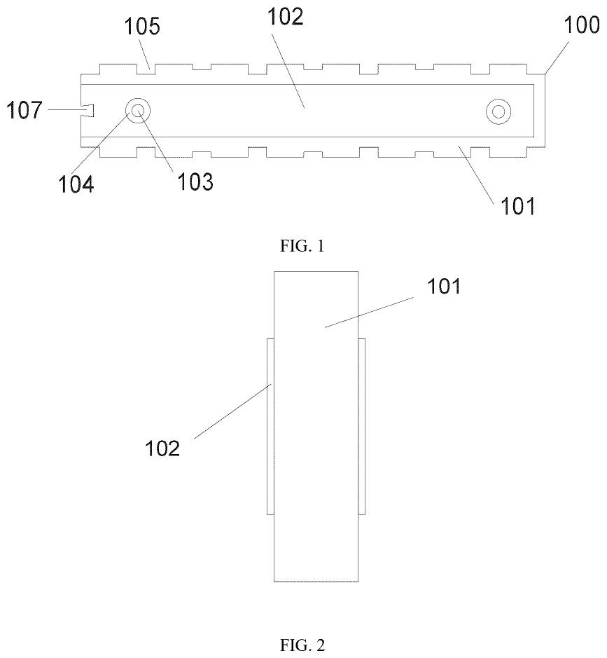

According to an embodiment of the present invention, a dust collection plate is provided. Referring to FIG. 1 and FIG. 2, the dust collection plate includes a body 100, where the body 100 includes a rigid insulation layer 101 and a conductive layer 102, the conductive layer 102 is located on an upper surface and a lower surface of the rigid insulation layer 101, and a plurality of fixed mounting positions 105 are provided on an edge of the body 100 in a length direction thereof.

It should be noted that by providing the rigid insulation layer 101, and under the premise of guaranteeing the strength and stability of the dust collection plate, a thickness of the dust collection plate is minimized, it is lightweight with low material and transportation costs, it is corrosion-resistant compared with the metal pole plate, which helps to prolong the service life, and there is no burr, which avoids the influence on the purification efficiency due to tip discharge. The purification device made of the dust collection plate with the structure has a larger effective ventilation area per unit area, a larger dust collection area and a larger dust holding capacity, so that the efficiency is higher and the maintenance cycle is longer.

Specifically, the conductive layer 102 is set as a long strip shape, which may be provided with one or more strips.

Referring to FIG. 1, in the dust collection plate of this embodiment, the fixed mounting positions 105 are set as slotted openings and/or semicircular openings, and adjacent fixed mounting positions 105 have different opening depths.

The fixed mounting positions with a minimum depth are used to connect a fixed separator, the fixed separator is an insulation adhesive and/or a rigid insulation part, and the fixed mounting positions with a maximum depth serve as avoiding ports.

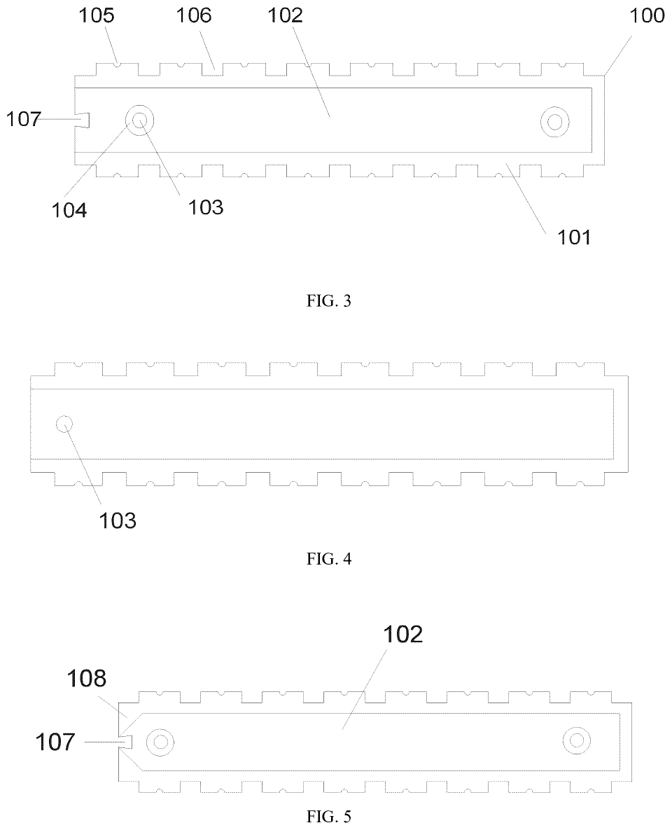

Referring to FIG. 3, in the dust collection plate of this embodiment, a plurality of avoiding ports 106 are further provided on the edge of the body 100 in a length direction thereof, the fixed mounting positions 105 are provided spaced apart from the avoiding ports 106, the avoiding ports 106 have different opening depths from the fixed mounting positions 105, and the avoiding ports 106 and the fixed mounting positions 105 are set as slotted openings and/or semicircular openings.

Specifically, referring to FIG. 3, the fixed mounting positions 105 are set as shallow arc openings, and the avoiding ports 106 are set as slotted openings. Referring to FIG. 7, the fixed mounting positions 105 are shallow arc openings, and the avoiding ports 106 are set as semicircular openings. In addition, the fixed mounting positions 105 and the avoiding ports 106 may also be set as slotted openings. Referring to FIG. 8, the fixed mounting positions 105 and the avoiding ports 106 are set as slotted openings, while a deepened port with a semicircular opening is also provided on a bottom surface of each of the fixed mounting positions 105.

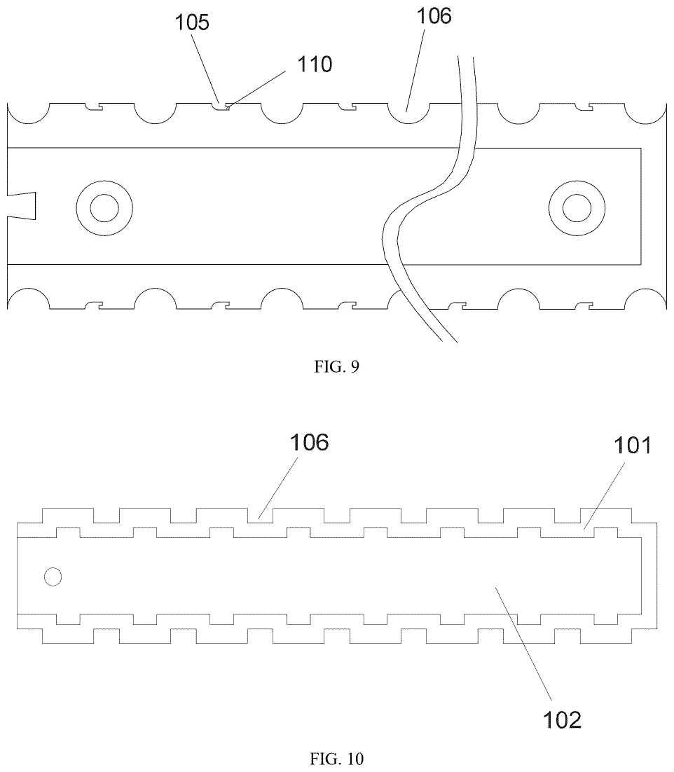

Referring to FIG. 1 and FIG. 9, in the dust collection plate of this embodiment, grooves 110 extending in a length direction of the body 100 are formed inside the fixed mounting positions 105.

It should be noted that each of the grooves 110 increases the contact area between the fixed mounting positions 105 and the adhesive body, a vertical gluing of the purification and dust removal module can be realized, and the vertical gluing can be carried out on both sides at the same time, so the production speed is faster; with the design of the groove 110, when the vertical gluing is carried out, more of the adhesive body can be infused into the groove 110, and a bonding of the adhesive body and the dust collection plate can be formed in the groove 110, so the contact area is larger, and the firmness is better.

Referring to FIG. 1, in the dust collection plate of this embodiment, an end portion of the body 100 serves as a power connection end, and the power connection end is provided with a necked receiving power connection port 107.

It should be noted that a metal wire/rod is inserted into the necked receiving power connection port 107 to achieve power connection, and the necked receiving power connection port 107 exerts an inward force on the metal wire/rod, resulting in a higher fitness between the metal wire/rod and the conductive layer 102.

Referring to FIG. 1, the necked receiving power connection port 107 includes an opening end and a closed end, a protruding end is arranged between the opening end and closed end, and the metal wire/rod enters the power connection port 107 from the opening end. The cross-section of the necked receiving power connection port 107 is an isosceles trapezoid, the upper bottom of the isosceles trapezoid serving as the opening end, the lower bottom of the isosceles trapezoid serving as the closed end, and the lateral sides of the isosceles trapezoid serving as the protruding end. By using the protruding end to exert an inward force on metal wire/rod, the power connection port 107 is clamped with the metal wire/rod.

Preferably, an included angle between the protruding end and the horizontal direction is 10-25°. When the included angle is less than 10°, the power connection port 107 is more prone to be clamped with the metal wire/rod, with poor firmness after clamping. When the included angle is greater than 25°, the power connection port 107 is more difficult to be clamped with the metal wire/rod, with better firmness after clamping. When the included angle is equal to 15°, the power connection port 107 is more prone to be clamped with the metal wire/rod, with better firmness after clamping.

Meanwhile, an arc matched with the metal wire/rod can be arranged at the protruding end, such that the metal wire/rod partially falls into the arc after being clamped into the power connection port 107, making the clamping tighter.

Moreover, the cross-section of the necked receiving power connection port 107 may also be set as a circular arc, the contact area between the circular arc and the metal wire/rod is increased, and the power connection stability is better. Preferably, the circular arc is a major arc. The diameter of the metal wire/rod is matched with the circular arc, with a gap of 0.2-1 mm. When the gap is less than 0.2 mm, the gap between the metal wire/rod and the circular arc is too small to clamp easily, and the requirement of the manufacturing process is too high. When the gap is greater than 1 mm, the gap between the metal wire/rod and the circular arc is excessive, resulting in loosing after clamping and poor power connection stability.

Referring to FIG. 1, in the dust collection plate of this embodiment, the conductive layer 102 has a length less than or equal to that of the rigid insulation layer 101, and the conductive layer 102 extends to the power connection end.

In the dust collection plate of this embodiment, one end portion of the conductive layer 102 located at the power connection end has an area less than that of the other end portion of the conductive layer 102, to improve the electrical safety. During assembling, a plurality of dust collection plates are butted inside the frame body to form a purification device. Meanwhile, the end portion of the body 100 and the frame body are insulated by providing an insulator therebetween, and the area of the end portion of the conductive layer 102 located at the power connection end is reduced, which can prevent an electrical safety distance between the end portion of the conductive layer 102 and the frame body from being too close and avoid the influence on the stable operation in the later stage.

Referring to FIG. 5, an end portion of the conductive layer 102 located at the power connection end is inclined towards a direction away from the power connection end from an entrance of the power connection port 107, a first electrical safety area 108 is present between the power connection end and the conductive layer 102, two first electrical safety areas 108 are symmetrically provided and the first electrical safety area 108 is triangular, and the symmetrical structural design can maintain the uniformity of the electrical safety distance.

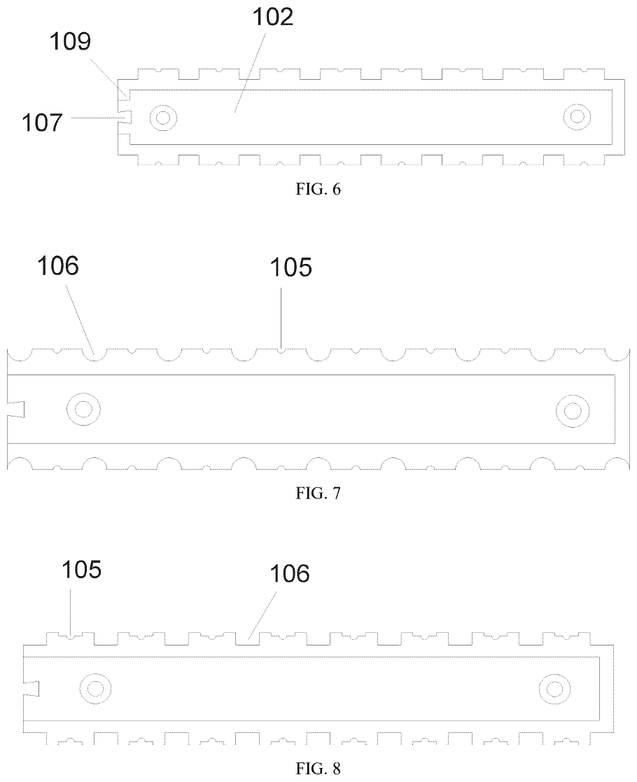

Referring to FIG. 6, an end portion of the conductive layer 102 located at the power connection end is provided with a notch, the notch forms a second electrical safety area 109, two second electrical safety areas 109 are symmetrically provided and the second electrical safety areas 109 are square, and the symmetrical structural design can maintain the uniformity of the electrical safety distance. Specifically, the conductive layer 102 extends to an area between the notch and the power connection port 107.

Referring to FIG. 1, in the dust collection plate of this embodiment, an end portion of the body 100 is provided with a process circular hole 103, the process circular hole 103 is farther away from the end portion of the body 100, and after the assembling, the process circular hole 103 is in a bare state, at which time an insulation gap 104 is provided between the process circular hole 103 and the conductive layer 102 in order to form a safety distance.

Referring to FIG. 4, in the dust collection plate of this embodiment, a minimum spacing between the process circular hole 103 and the end portion of the body 100 is 0-4 mm, the process circular hole 103 is moved towards the end portion of the body 100, and when assembled, a plurality of dust collection plates are butted inside the frame body to form a purification device, at which time the process circular hole 103 also functions as a power connection port 107, resolving the purification blind zone generated in the vicinity of the process circular hole 103.

Referring to FIG. 10 and FIG. 11, in the dust collection plate of this embodiment, spacings between an edge of the conductive layer 102 and the edge of the body 100 are equal.

It should be noted that according to the shapes of the fixed mounting positions 105 and the avoiding ports 106, the edge shape of the conductive layer 102 is designed to make full use of the effective area of the body 100, to maximize the proportion of the conductive layer 102 and not to affect electrical safety simultaneously. This helps to improve the area of the purification device (or dust collection plate) that captures particulate matter, prolong the action time on particulate matters, improve the purification efficiency of the particulate matters and correspondingly increase the dust holding capacity of the purification device.

Referring to FIG. 11, the fixed mounting positions 105 and the avoiding ports 106 are semicircular openings; therefore, the edge of the conductive layer 102 resembles a wave shape. Referring to FIG. 10, the avoiding ports 106 are slotted openings, and the fixed mounting positions 105 are located between adjacent avoiding ports 106; therefore, the edge of the conductive layer 102 resembles a rectangular tooth shape.

In order to verify whether different shapes of the conductive layer have an effect on the purification efficiency of the purification device, the inventor conducted the following experiments: by comparing a purification device with a length of 500 mm, a width of 400 mm, and a thickness of 50 mm, in circumstances where the ionization device and the ionization voltage are the same at the front end, and in the same environment, the PM2.5 purification efficiency of the purification device was compared under two air velocities, and the experimental data are shown in Table 1.

TABLE 1

| | | | Gap of | | | |
|---|---|---|---|---|---|---|
| | Shape of | Size of | Dust | | Surface | PM2.5 |
| | Dust | Purification | Collection | Air | Air | Purification |
| Experimental | Collection | Device | Plate | Volume | Velocity | Efficiency |
| Scheme | Plate | mm | mm | m³/h | m/s | % |
| 1 | Waveform | 500*400*50 | 1.5 | 1440 | 2 | 99 |
| | Square | 500*400*50 | 1.5 | 1440 | 2 | 98 |
| | Ordinary | 500*400*50 | 1.5 | 1440 | 2 | 97 |
| 2 | Waveform | 500*400*50 | 1.5 | 2160 | 3 | 98 |
| | Square | 500*400*50 | 1.5 | 2160 | 3 | 97 |
| | Ordinary | 500*400*50 | 1.5 | 2160 | 3 | 94 |

From Table 1, it can be concluded that the conductive layer 102 with the waveform (referring to FIG. 11) has the maximum proportion, and its PM2.5 purification efficiency is the largest at two air velocities; the proportion of the conductive layer 102 with the square shape (referring to FIG. 10) ranks second only to the waveform, and its PM2.5 purification efficiency is also relatively high; and at a high air velocity of 3 m/s, the proportion of the conductive layer 102 with the ordinary shape (referring to FIG. 7) is the smallest, and the gap in efficiency between it and the waveform and square is the largest and most pronounced. Therefore, increasing the proportion of the conductive layer 102 is beneficial for guaranteeing the PM2.5 purification efficiency of the purification device, and the improvement of the efficiency will correspondingly increase the dust holding capacity of the purification device.

Referring to FIG. 1 and FIG. 2, in the dust collection plate of this embodiment, the conductive layer 102 is made of a conductive material and an additive, the conductive material includes graphite, graphene or conductive ink, and the additive includes organosilicon.

The rigid insulation layer 101 is made of one or more of polycarbonate, polypropylene, ABS plastic, polyamide, polyformaldehyde, polytetrafluoroethylene, glass fiber reinforced plastic and phenolic plastic. Preferably, the rigid insulation layer 101 is made of glass fiber reinforced plastic (FRP), the FRP is a functional new material made of synthetic resins and glass fibers by a composite process, with a relative density of 1.5 to 2.0, which is only ¼ to ⅕ of carbon steel, but with a tensile strength close to or even exceeding that of carbon steel, and a strength comparable to that of high-grade alloy steel; by utilizing its high strength, a thickness of the dust collection plate is minimized. The purification device made of the dust collection plate with the structure has a larger effective ventilation area per unit area, a larger dust collection area and a larger dust holding capacity, so that the efficiency is higher and the maintenance cycle is longer.

Referring to FIG. 1 and FIG. 2, in the dust collection plate of this embodiment, the rigid insulation layer 101 has a thickness of 0.1-2 mm, and the conductive layer 102 has a thickness of 0.005-0.2 mm. If the rigid insulation layer 101 is too thin, for example, less than 0.1 mm, the support strength is not enough and the dust collection plates are easy to deform; if the rigid insulation layer 101 is too thick, for example, greater than 2 mm, the dust collection plate is thicker, the effective ventilation area per unit area of the corresponding purification device becomes smaller, and the purification efficiency and the dust holding capacity are obviously reduced; the good range of 0.1-2 mm allows for a balance between the supportability, the thickness, maintaining the purification efficiency and the dust holding capacity. If the conductive layer 102 is too thin, for example, less than 0.005 mm, which makes it difficult to produce and process, so the layer thickness is not easy to control; if the conductive layer 102 is too thick, for example, greater than 0.2 mm, which makes it difficult to process, so the adhesion force is not enough, and there is a risk of the conductive layer on the outside falling off; and the range of 0.005-0.2 mm allows for a balance between machining difficulty and stability.

In order to verify whether different thicknesses of the rigid insulation layer have an effect on the purification efficiency of the purification device, the inventor conducted the following experiments: by comparing a purification device with a length of 500 mm, a width of 300 mm, and a thickness of 45 mm, in circumstances where the ionization device and the ionization voltage are the same at the front end, and in the same environment, effects of different thicknesses of the rigid insulation layer on the PM2.5 purification efficiency was compared, and the experimental data are shown in Table 2.

TABLE 2

| | | Gap of | Thickness | | | |
|---|---|---|---|---|---|---|
| | Size of | Dust | of Rigid | | Surface | PM2.5 |
| Shape of Dust | Purification | Collection | Insulation | Air | Air | Purification |
| Collection | Device | Plate | layer | Volume | Velocity | Efficiency |
| Plate | mm | mm | mm | m³/h | m/s | % |
| Ordinary | 500*300*45 | 1.5 | 0.09 | 1080 | 2 | 49 |
| Ordinary | 500*300*45 | 1.5 | 0.1 | 1080 | 2 | 99 |
| Ordinary | 500*300*45 | 1.5 | 1 | 1080 | 2 | 96 |
| Ordinary | 500*300*45 | 1.5 | 2 | 1080 | 2 | 91 |
| Ordinary | 500*300*45 | 1.5 | 2.1 | 1080 | 2 | 85 |
| Ordinary | 500*300*45 | 1.5 | 2.5 | 1080 | 2 | 78 |

From Table 2, it can be concluded that the thickness of the rigid insulation layer is less than 0.1 mm, the support strength is not enough, the dust collection plate is easy to deform, and the PM2.5 purification efficiency is very low; the thickness of the rigid insulation layer is greater than 2 mm, the thickness of the dust collection plate is thicker, the effective ventilation area per unit area of the corresponding purification device becomes smaller, and the purification efficiency is obviously reduced; and the good range of 0.1-2 mm allows for a balance between the support strength, the thickness, maintaining the purification efficiency and the dust holding capacity.

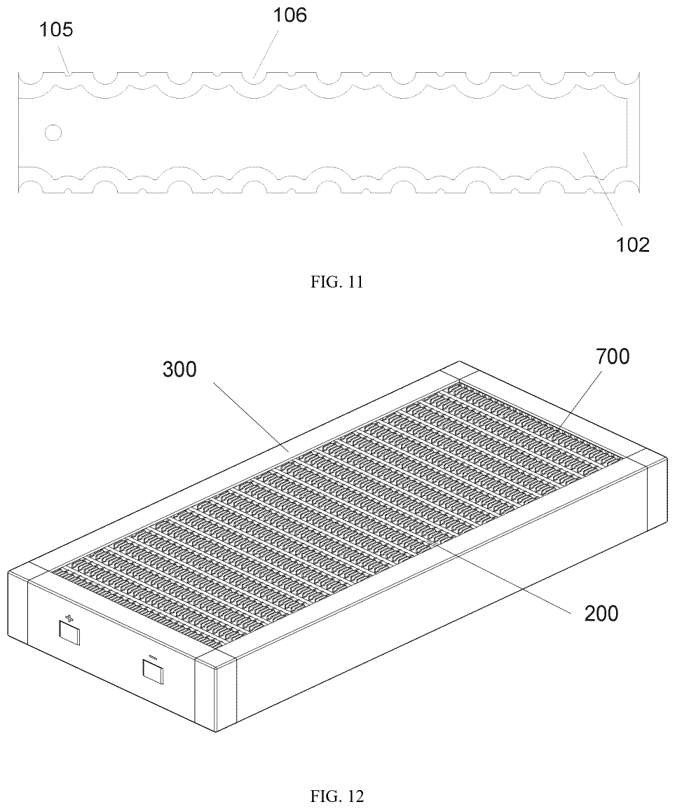

According to an embodiment of the present invention, a purification device is provided. Referring to FIG. 12, the purification device includes a frame body 300, where a plurality of ground dust collection plates and high-voltage dust collection plates provided in an alternately superimposed manner are provided inside the frame body 300, and the ground dust collection plates and the high-voltage dust collection plates use the dust collection plate 700.

Referring to FIG. 12, in the purification device of this embodiment, the ground dust collection plates and the high-voltage dust collection plates are connected with a fixed separator 200 respectively, and the fixed separator 200 is an insulation adhesive and/or a rigid insulation part.

Specifically, the insulation adhesive has a high adhesive strength and is resistant to high and low temperature impacts, such as the commercially available PUR adhesive; the hot melt adhesive can also be used for fixing, and the purification device fixed by the hot melt adhesive is limited in its application areas, that is, it cannot be used in the environment where there is a big difference in temperature throughout the year or between morning and evening and the hot melt adhesive is easy to soften at high temperatures and brittle and crack at low temperatures.

After filling the shallow arc opening with the insulation adhesive to fix, an approximately circular adhesive body is formed, and an equidistant safety distance is formed between the circular adhesive body and the avoiding port 106. Meanwhile, a size of the shallow arc opening is adapted to the adhesive quantity, the adhesive body is flush with the edge of the dust collection plate or slightly lower than the edge of the dust collection plate, i.e., a part of the adhesive body is in the shallow arc opening, and a part of the adhesive body is bonded with the dust collection plate to form an approximately circular adhesive body and maintain the surface flatness and aesthetics. Alternatively, the fixed mounting positions 105 are semicircular openings, the avoiding ports 106 are deep arc openings, and after filling the semicircular opening with the insulation adhesive to fix, an approximately circular adhesive body is formed, and an equidistant safety distance is formed between the circular adhesive body and the avoiding port 106. Meanwhile, the size of the semicircular opening is adapted to the adhesive quantity, the adhesive body is flush with the edge of the dust collection plate or slightly lower than the edge of the dust collection plate after gluing, i.e., a part of the adhesive body is in the semicircular opening, and a part of the adhesive body is bonded with the dust collection plate to form an approximately circular adhesive body and maintain the surface flatness and aesthetics. The design of the equidistant safety distance utilizes the natural settling of the insulation adhesive, as well as the bonding of the insulation adhesive and the dust collection plate to form the approximately circular adhesive body, mainly including the two forms mentioned previously; the design of the equidistant safety distance can improve the proportion of the conductive layer of the dust collection plate as much as possible, thereby improving the purification efficiency and the dust holding capacity of the purification device, and prolonging the maintenance cycle; and the design of the equidistant safety distance is such that in the later stage of the operation of the purification device, a layer of dust will adhere to the adhesive body surface and the dust collection surface. When encountering high humidity and other environments, the dust will have a certain conductivity, which will indirectly reduce the safety distance of the purification device. At this point, the dust collection plates and adhesive body connected to different potential voltages will generate leakage current due to the reduction of the electrical safety distance, thereby reducing the purification efficiency of the purification device and shortening the maintenance cycle.

Specifically, at the contact point between the rigid insulating part and the dust collection plate 700, a width of the rigid insulation part is increased in a length direction of the dust collection plate 700. Meanwhile, a seam for the dust collection plate is formed in the rigid insulation part to better clamp the dust collection plate 700, increase the fixed contact area with the dust collection plate 700, and promote the stability of the spacing between the dust collection plates 700. Moreover, the insulation adhesive can be bonded with the rigid insulation part, one side of the dust collection plate 700 is fixed using the rigid insulation part, and the other side is fixed using the insulation adhesive. Moreover, after being clamped with the dust collection plate 700, the rigid insulation part is fixed using the insulation adhesive to increase the stability.

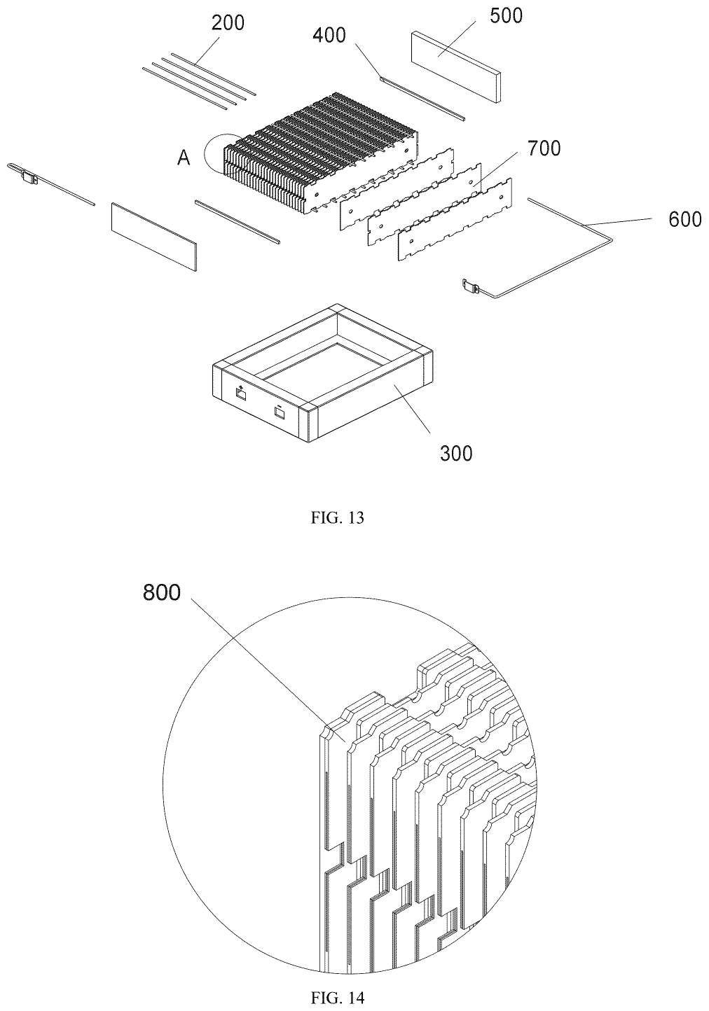

Referring to FIG. 12 to FIG. 14, in the purification device of this embodiment, the ground dust collection plates and the high-voltage dust collection plates are provided in a 180° staggered manner, at which time insulators 500 are provided between the frame body 300 and the end portions of the ground dust collection plates, and between the frame body 300 and the end portions of the high-voltage dust collection plates.

Specifically, an electric conductor 400 is located at an end portion of the dust collection plate 700, while the electric conductor 400 is embedded in the power connection port 107, an insulation adhesive is coated outside the electric conductor 400, and the insulator 500 is located between the electric conductor 400 and the frame body 300. Meanwhile, the ground dust collection plates and the high-voltage dust collection plates are electrically connected with the frame body 300 by means of wires 600, respectively.

Preferably, the insulator 500 may be an insulation adhesive layer or a hollow plate. Specifically, the hollow plate is provided between the frame body 300 and the end portion of the ground dust collection plate, and the insulation adhesive layer is provided between the frame body 300 and the end portion of the high-voltage dust collection plate.

Referring to FIG. 1 to FIG. 14, in the purification device of this embodiment, a gap 800 exists between the end portion of the ground dust collection plate and the end portion of the high-voltage dust collection plate, at which time a minimum spacing between the process circular hole 103 and the end portion of the body 100 is in the range of [0,4] mm. In some other embodiments, the end portions of the ground dust collection plates are flush with the end portions of the high-voltage dust collection plates, i.e., there is no gap between end portions of the ground dust collection plates and the high-voltage dust collection plates, at which time a minimum spacing between the process circular hole 103 and the end portion of the body 100 is (0,4] mm, and the end portion of the body 100 is insulated.

Referring to FIG. 1 and FIG. 12 to FIG. 14, the purification device of this embodiment further includes a high-voltage power supply, and the high-voltage power supply is located inside or outside the frame body 300, that is, the high-voltage power supply may be arranged inside or outside.

Moreover, a plurality of ground dust collection plates and high-voltage dust collection plates provided in an alternately superimposed manner form a purification unit, a plurality of purification units are provided in the frame body, insulation plates are provided between adjacent purification units, and the insulation plates play a role in fixing and insulating. A plurality of purification units are spliced together to accommodate the purification needs of a larger sized working surface.

The present invention has been described in detail above, and the above mentioned is only a preferred embodiment of the present invention and is not intended to limit the implementation scope of the present invention, that is, all equivalent variations and modifications made within the claims of the present invention shall be included within the scope of the present invention.

What is claimed is:

1. A dust collection plate, comprising a body, wherein the body comprises a rigid insulation layer and a conductive layer, the conductive layer is located on an upper surface and a lower surface of the rigid insulation layer, and a plurality of fixed mounting positions are provided on an edge of the body in a length direction thereof.

2. The dust collection plate according to claim 1, wherein the fixed mounting positions are set as slotted openings and/or semicircular openings, and adjacent fixed mounting positions have different opening depths.

3. The dust collection plate according to claim 1, wherein a plurality of avoiding ports is also provided on the edge of the body in a length direction thereof, the fixed mounting positions are provided spaced apart from the avoiding ports, the avoiding ports have different opening depths from the fixed mounting positions, and the avoiding ports and the fixed mounting positions are set as slotted openings and/or semicircular openings.

4. The dust collection plate according to claim 1, wherein an end portion of the body serves as a power connection end, and the power connection end is provided with a necked receiving power connection port.

5. The dust collection plate according to claim 4, wherein the conductive layer has a length less than or equal to that of the rigid insulation layer, and the conductive layer extends to the power connection end.

6. The dust collection plate according to claim 1, wherein an end portion of the body is provided with a process circular hole, and a minimum spacing between the process circular hole and the end portion of the body is 0-4 mm.

7. The dust collection plate according to claim 1, wherein spacings between an edge of the conductive layer and the edge of the body are equal.

8. The dust collection plate according to claim 1, wherein the conductive layer is made of a conductive material and an additive, the conductive material comprising graphite, graphene or conductive ink, and the additive comprising organosilicon; and the rigid insulation layer is made of one or more of polycarbonate, polypropylene, ABS plastic, polyamide, polyformaldehyde, polytetrafluoroethylene, glass fiber reinforced plastic and phenolic plastic.

9. The dust collection plate according to claim 8, wherein the rigid insulation layer has a thickness of 0.1-2 mm, and the conductive layer has a thickness of 0.005-0.2 mm.

10. A purification device, comprising a frame body, wherein a plurality of ground dust collection plates and high-voltage dust collection plates provided in an alternately superimposed manner are provided inside the frame body, the ground dust collection plates and the high-voltage dust collection plates use the dust collection plate according to claim 1, the ground dust collection plates and the high-voltage dust collection plates are connected with a fixed separator, respectively, and the fixed separator is an insulation adhesive and/or a rigid insulation part.

11. The purification device according to claim 10, wherein the ground dust collection plates and the high-voltage dust collection plates are provided in a 180° staggered manner, and insulators are provided between the frame body and the end portions of the ground dust collection plates, and between the frame body and the end portions of the high-voltage dust collection plates.

12. The purification device according to claim 10, further comprising a high-voltage power supply, wherein the high-voltage power supply is located inside or outside the frame body.

13. The purification device according to claim 11, wherein a plurality of ground dust collection plates and high-voltage dust collection plates provided in an alternately superimposed manner form a purification unit, a plurality of purification units are provided in the frame body, and insulation plates are provided between adjacent purification units.
